(19) United States
(12) Patent Application Publication
(10) Pub. No.: US 2023/0171452 A1
(43) Pub. Date: Jun. 1, 2023

(54) SYSTEMS AND METHODS TO GENERATE PERSONALIZED BENEFIT ITEMS FOR SUBSCRIBERS OF A MEMBERSHIP PLATFORM

(71) Applicant: PATREON, INC., San Francisco, CA (US)

(72) Inventor: George Edward Bonner, Oakland, CA (US)

(21) Appl. No.: 17/242,167

(22) Filed: Apr. 27, 2021

(51) Int. Cl. H04N 21/262; H04N 21/254; H04N 21/258; H04N 21/4784; G06Q 50/00

(52) U.S. Cl. CPC H04N 21/26225; H04N 21/2541; H04N 21/25816; H04N 21/26241; H04N 21/4784; G06Q 50/01

(57) ABSTRACT

Systems and methods are provided to generate personalized benefit items for subscribers of a membership platform. Exemplary implementations may: effectuate presentation of a reward fulfillment user interface; obtain input information conveying input by the content creators into the reward fulfilment user interface; obtain subscribership information for the content creators; determine individual recommendations for modifying individual sets of one of more modifiable features of individual personalizable benefit items based on the subscribership information; effectuate presentation of the individual recommendations in the reward fulfillment user interface; and/or perform other operations.

### FIELD

The disclosure relates to systems and methods to generate personalized benefit items for subscribers of a membership platform.

### BACKGROUND

Different platforms may be utilized by entities seeking contributions from the general public to obtain a needed service(s) and/or resource(s). Some of these platforms facilitate raising resources (i.e., funds) from the users through monetary contributions or donations to support a project. Oftentimes, supporters of a project are given rewards or special perks, where the size and/or exclusivity of the rewards or special perks may depend on the amount contributed.

### SUMMARY

A membership platform may be comprised of users including one or more of content creators, subscribers, and/or other users. Content creators may be users of the membership platform who offer content (also referred to as “benefit items”) to subscribers to the content creators in exchange for consideration. A “benefit item” may refer to a good and/or service. A good may comprise a physical good and/or a digital good (e.g., “online” content). In some implementations, subscribers may donate funds to a content creator such that the benefit item may be the altruism in supporting the content creator. Subscribers may be users of the membership platform who subscribe, through payment of a one-time and/or recurring (e.g., monthly) fee, to one or more content creators. A subscriber of an individual content creator may obtain access to benefit items offered through the membership platform by virtue of being a subscriber to the individual content creator. A subscriber of an individual content creator may obtain preferential access to benefit items offered through the membership platform by virtue of being a subscriber to the individual content creator. Preferential access may refer to subscriber-only access to benefit items and/or other content. Preferential access may refer to tiered levels of access to benefit items and/or other content. Different levels of access may offer different quantities, content types, and/or combinations of benefit items. Different levels may correspond to different amounts of consideration paid by the given subscriber. In some implementations, other users of the membership platform may obtain limited access to benefit items. In some implementations, other users may be non-paying users and/or one-time visitors to the membership platform.

The present disclosure addresses one or more problems in determining what kind of rewards, in the form of personalized benefit items, to give their subscribers that are of a more personal and unique nature. A simple “shout out” or mass produced merchandise item may seem impersonal and not unique in the scheme of things. If a content creator desires truly unique and custom merch, they typically would have to go through many extra steps to source the merch, order it, review it, and send it to the subscriber. This is generally not a good use of the content creator's time, money, or effort. Accordingly, there is a need to determine, in a computationally efficient manner, a way generate personalized benefit items for subscribers to content creator.

One aspect of the present disclosure relates to a system configured to generate personalized benefit items for subscribers of a membership platform. The system may include one or more hardware processors configured by machine-readable instructions and/or other components. The machine-readable instructions may include one or more computer program components. The computer program components may include one or more of a presentation component, an identification component, a recommendation component, and/or other computer program components.

The presentation component may be configured to effectuate presentation of a reward fulfillment user interface to computing platforms of content creators of a membership platform. The content creators may offer benefits items to subscribers of the membership platform in exchange for requested amounts of consideration. The reward fulfillment user interface may facilitate the creation of personalized ones of the benefit items to the subscribers.

The identification component may be configured to obtain input information conveying input by the content creators into the reward fulfilment user interface. The input by individual content creators may include identification of one or more of individual personalizable benefit items, individual subscribers to the individual content creators, and/or other information. The individual personalizable benefit items may have individual sets of one or more modifiable features. By way of non-limiting illustration, the input information may convey first input by a first content creator identifying one or more of a first benefit item, a first subscriber, a second subscriber, and/or other information.

The identification component may be configured to, responsive to the identification of the individual subscribers, obtain subscribership information for the content creators. The subscribership information may characterize subscribership of the individual subscribers to the individual content creators. By way of non-limiting example, responsive to the identification of the first subscriber, first subscribership information characterizing the subscribership of the first subscriber to the first content creator may be obtained. By way of non-limiting example, responsive to the identification of the second subscriber, second subscribership information characterizing the subscribership of the second subscriber to the first content creator may be obtained.

The recommendation component may be configured to determine individual recommendations for modifying the individual sets of one or more modifiable features of the individual personalizable benefit items based on the subscribership information and/or other information. The individual recommendations may include modifications of individual modifiable features to reflect the subscribership information and/or other information. By way of non-limiting example, a first recommendation, a second recommendation, and/or other recommendations may be determined. The first recommendation may include a first modification of a first modifiable feature of the first benefit item to reflect the first subscribership information. The second recommendation may include a second modification of the first modifiable feature of the first benefit item to reflect the second subscribership information.

The presentation component may be configured to effectuate presentation of the individual recommendations in the reward fulfilment user interface presented on the computing platforms of the content creators. By way of non-limiting illustration, the first recommendation, the second recommendation, and/or other recommendations may be presented on the reward fulfilment user interface presented on a first computing platform of the first content creator.

As used herein, any association (or relation, or reflection, or indication, or correspondence) involving servers, processors, remote computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an example membership system.

FIG. 2 illustrates a system configured to generate personalized benefit items for subscribers of a membership platform, in accordance with one or more implementations.

FIG. 3 illustrates an example database.

FIG. 4 illustrates a method to generate personalized benefit items for subscribers of a membership platform, in accordance with one or more implementations.

FIG. 5 illustrated a user interface, in accordance with one or more implementations,

FIG. 6 illustrates a user interface, in accordance with one or more implementations.

### DETAILED DESCRIPTION

Some entities may seek to obtain funds through subscriptions. Such entities may utilize online membership platforms that allow consumers to sign up for ongoing payments in exchange for rewards and/or other membership benefits. Entities seeking funding may be content creators, for example, artists, musicians, educators, speakers, etc. Content creators may create content, which may refer to one or more of information, experiences, products, and/or other content provided to an audience or end-user, whether it be digital, analog, virtual, and/or other form. For example, types of content may include but is not limited to online content such as video content, podcasts, photographic art, webcomics, do-it-yourself crafts, digital music, performance art, and/or other types of content. Content creators may utilize membership platforms that allow consumers to become subscribers of the content creator. As subscribers, consumers may contribute or donate money to a content creator on a recurring (e.g., weekly or monthly) basis and/or per piece of content created by the content creator. Content creators may interact with subscribers and/or prospective subscribers (e.g., consumers that show interest in the content created by content creators) in a variety of ways.

The content creators may want to send personalized benefit items to their subscribers. The personalized benefit items may differ from the ongoing or recurring benefits the subscribers may receive by virtue of their subscribership. One or more implementations presented here in may facilitate the creation of such personalized benefit items that are individualized for individual subscribers.

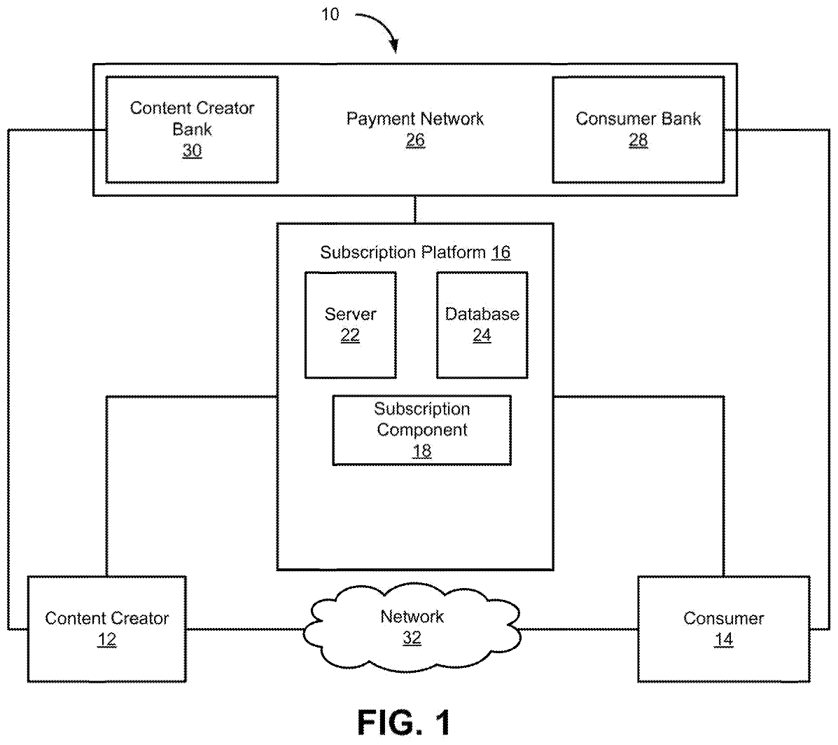

FIG. 1 illustrates an example subscriber-based membership system 10 (sometimes referred to herein as a “membership platform”). A content creator 12 may register and set up a creator account with subscription platform 16. Content creator 12 may create a page on a website hosted by server 22 of subscription platform 16 and input relevant information. Content creator 12 may input information associated with and/or relevant to content creator 12 via subscription component 18, such as creation information, content information, subscribership information, subscription level information specifying desired and/or initial subscription levels, preferred revenue source information (e.g., preferred currency, currency source, and/or other information), and/or other information. A page created by content creator 12 may be built using such information to make potential consumers aware of how content creator 12 may wish to be supported/receive support for his/her content creation in addition to subscribership revenue. Content creator 12 may set up a content creator account with subscription platform 16 through subscription component 18 or another appropriate component allowing content creator 12 to register with subscription platform 16. Various types of information regarding content creator 12 may be input into subscription platform 16, some of which may be information identifying content creator 12.

Consumer 14 (also referred to as a “subscriber”) may set up a subscriber account with subscription platform 16. In setting up the subscriber account, consumer 14 may input demographic information relevant to consumer 14 (e.g., age, income, job, etc.). Information identifying consumer 14 (e.g., name, a picture, a phone number, etc.) may be input by consumer 14 when setting up the subscriber account. Through the page created by content creator 12, a consumer 14 may pledge to donate a given amount of money to content creator 12 every time content creator 12 creates content. For example, if content creator 12 is an artist, consumer 14 may pledge to donate ten dollars each time content creator 12 creates a piece of art.

In order to remit payment to content creator 12, consumer 14 may set up a payment mechanism through subscription platform 16 as part of setting up his/her subscriber account. When subscription platform 16 is notified or determines that content creator 12 has created content, subscription platform 16 may access payment network 26 to obtain and/or transfer the pledged amount from consumer bank 28 to content creator bank 30. Alternatively (or in addition to per content pledge donations), consumer 14 may pledge to donate a given amount to content creator 12 on a recurring basis through subscription platform 16. For example, consumer 14 may pledge to donate five dollars each month to content creator 12, where each month, subscription platform 16 may access payment network 26 to obtain and transfer the pledged amount from consumer bank 28 to content creator bank 30. It should be understood that consumer 14 may have an established relationship with consumer bank 28, and that content creator 12 may have an established relationship with content creator bank 30. It should be noted that subscription platform 16 may retain a portion, such as some percentage, of the pledged amount, as a fee for hosting the page created by content creator 12, providing payment services, etc.

As consideration for the pledged donations, content creator 12 may provide some type of preferential access to consumer 14 in the form of benefit items including online content, physical content, and/or other content. Content creator 12 may specify tiers of preferential access based upon the amount of money consumer 14 pledges to donate and/or depending on whether the pledged donation is a recurring donation or a per content donation. The amounts and/or types of pledged donations that may be made by consumer 14 to back content creator 12 may be referred to as subscription levels.

For example, in return for a monthly, recurring dollar amount of donation, content creator 12 may provide a high-resolution digital image of the artwork created during that month to consumer 14. In exchange for a weekly, recurring dollar amount of donation, content creator 12 may provide a high-resolution digital image of the artwork created during that month as well as a time-lapse video of content creator 12 creating the artwork. In exchange for another dollar amount per content donation, content creator 12 may provide a low-resolution digital image of the artwork. For another dollar amount per content donation, content creator 12 may engage in a live webchat or live meet-and-greet with consumer 14. Various types of preferential access may be provided by content creator 12 to consumer 14, and content creator 12 may specify the subscription level to preferential access correlation.

The preferential access may be provided to consumer 14 from content creator 12. For example, content creator 12 may email digital copies of artwork to consumer 14 over a communications network, such as a local area network (LAN), a wide area network (WAN), a wireless network (e.g., WiFi), a mobile communication network, a satellite network, the Internet, fiber optic, coaxial cable, infrared, radio frequency (RF) or any other suitable network. The preferential access may be provided to consumer 14 from content creator 12 via subscriber platform 16. For example, the live webchat between content creator 12 and consumer 14 may be provided through some chat functionality of the page of content creator 12 hosted on server 22 of subscription platform 16, which may reside on communications network 32 or on another network (not shown).

It should be noted that not all subscription levels are necessarily associated with preferential access. Some consumers may be driven to subscribe to content creator 12 on the basis of created content rather than any special perks or rewards.

The specification and management of subscriptions on behalf of content creator 12 may be handled by subscription component 18 alone or in conjunction with database 24. For example, a user interface may be provided via subscription component 18 allowing content creator 12 to specify his/her desired subscription levels and corresponding preferential access, as well as his/her preferred sources of revenue. Subscription component 18 may receive the information input by content creator 12 and transmit the information for storage as one or more records, matrices, or other data structures in database 24 or within memory local to subscription component 18. Database 24 or the local memory of subscription component 18 may be configured in a suitable database configuration, such as a relational database, a structured query language (SQL) database, a distributed database, an object database, etc. Suitable configurations and database storage types will be apparent to persons having skill in the relevant art.

Content creator 12 may be associated with one or more of subscribership information, content information, creator profile information, creation information, and/or other information. The content creator 12 may be able to change (e.g., add, delete, update, modify, etc.) such information. Such changes may be input via subscription component 18 and reflected in its local memory and/or database 24. It should be understood that content creator 12 and/or consumer 14 may be an individual or some entity representative of an individual or group of individuals.

Content information may characterize benefit items that content creator 12 creates. The content information may include information defining and/or describing one or more of the type of benefit items created, the medium in which the benefit items is created and/or presented, the amount of benefit items created, and/or the frequency at which the benefit items is created. For example, type of benefit items and/or medium may indicate that content creator 12 creates paintings on canvas, develops video games for a mobile platform, performs in online musical performances, and/or other information. Amount may reflect that content creator 12 created a series of artwork comprising four paintings. Content frequency information may indicate that content creator 12 develops three video games over the course of six months. Such information may be stored in content database 24.

In some implementations, the subscribership information may characterize the subscribership of the individual subscribers to individual content creators. The subscribership information may include one or more of length of subscribership the individual subscribers to individual content creators, date of initial subscribership the individual subscribers to individual content creators, a subscription level the individual subscribers, rank among other subscribers to individual content creators, lifetime contribution amount the individual subscribers, identifying information of the individual subscribers, subscriber-initiated interactions, and/or other information. The identifying information of the individual subscribers may include one or more of name, username, demographics, email, and/or other information identifying an individual subscriber. The subscriber-initiated interactions may be characterized based on one or more of content of the interactions, form of the interactions, point in time of the interactions, and/or other information. The content of the interactions may include what was communicated. The form of interactions may indicate how the communication was made. By way of non-limiting illustration, communication may be made by one or more of chat, comments, posting of forum or message board, phone call, video chat, and/or other forms of communication.

Apart from providing preferential access to consumer 14, content creator 12 may engage with consumer 14 by interacting in a variety of ways. For example, content creator 12 may communicate with consumer 14 over email, one or more social media platforms, a messaging platform or other appropriate communication mechanisms or methods. It should be understood that such communication platforms or mechanisms may be embodied in communications network 32 allowing content creator 12 and consumer 14 to communicate outside of subscription platform 16. It should be understood that communication platforms or mechanisms may operate in conjunction with subscription platform 16 such that one or more of their respective functionalities may be utilized through subscription platform 16. For example, social media hyperlinks allowing information from content creator 12's page may be provided on the webpage allowing content creator 12 to share content creation progress updates with consumer 14. For example, content creator 12 may respond to a communication from consumer 14 posted on a comment section provided on content creator 12's page in a private message or as part of the comment thread. It should be noted that content creator 12 may engage a single consumer, e.g., consumer 14, one-on-one and/or may engage a group of consumers. For example, content creator 12 may post a “public” comment on his/her webpage that may be seen by any consumer that is a subscriber to content creator 12 and/or any consumer that may be a potential subscriber.

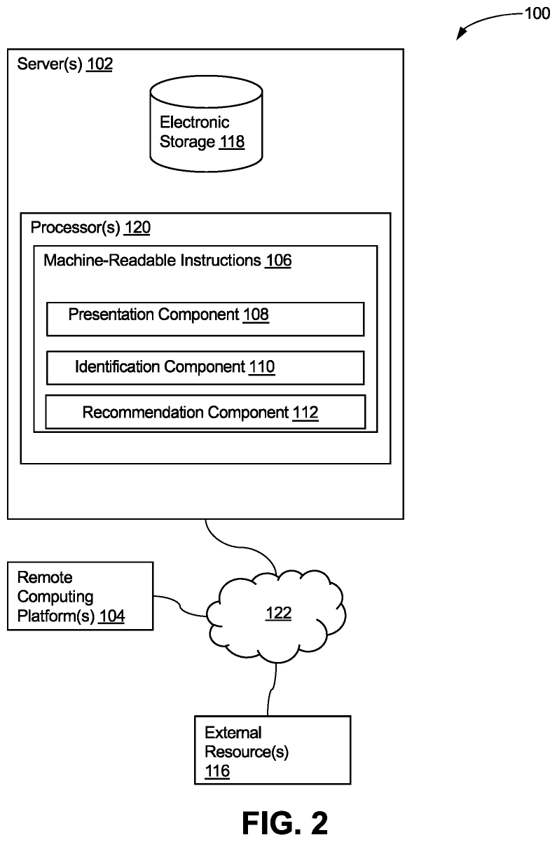

FIG. 2 illustrates a system 100 configured to generate personalized benefit items for subscribers of a membership platform. In some implementations, system 100 may include one or more of server(s) 102, remote computing platform(s) 104, and/or other components. The terms remote computing platform, client computing platform, and/or computing platform may be used interchangeably herein to refer to individual ones of the remote computing platform(s) 104. Server(s) 102 may be configured to communicate with one or more remote computing platforms 104 according to a client/server architecture and/or other architectures via one or more network(s) 122. In some implementations, one or more network(s) 122 may include the Internet and/or other networks. Remote computing platform(s) 104 may be configured to communicate with other remote computing platforms via server(s) 102 and/or according to a peer-to-peer architecture, a client-server architecture, and/or other architectures. Users may access system 100 via remote computing platform(s) 104.

It is noted the system 100 of FIG. 2 may be the same as, or included as part of, the system 10 shown in FIG. 1. For example, the server(s) 102 may be the same as or included in server 22. Network(s) 122 may be the same as or included in network 32. Individual remote computing platforms of one or more remote computing platforms 104 may be computing platforms utilized by content creator 12 and/or consumer 14 to access system 10 and/or system 100. Non-transitory electronic storage 118 may be the same as or included in database 24. Accordingly, those skilled in the art will recognize that although system 10 and system 100 are shown and described separately, they may comprise a single common system. However, in some implementations, the features and/or functionality of system 100 may be provided remotely as a separate system from system 10.

Server(s) 102 may be configured by machine-readable instructions 106. Machine-readable instructions 106 may include one or more computer program components. The computer program components may include one or more of a presentation component 108, an identification component 110, a recommendation component 112, and/or other computer program components.

Presentation component 108 may be configured to effectuate presentation of a reward fulfilment user interface to computing platforms of content creators of a membership platform and/or other user interfaces. The reward fulfilment user interface may facilitate the creation of personalized ones of the benefit items and/or online content to the subscribers. An instance of a user interface may include one or more user interface elements configured to facilitate user interaction with the user interface. By way of non-limiting illustration, user interface elements may include one or more text input fields, drop down menus, check boxes, display windows, virtual buttons, and/or other elements configured to facilitate user interaction. User interactions may include one or more of selecting, checking, drag-and-drop, entering information, and/or other user interactions.

The individual personalizable benefit items may have individual sets of one or more modifiable features. In some implementations, the individual personalizable benefit items may include tangible goods. The modifiable features may include features of one or more design components of the tangible goods. A tangible good may include a merchandise item. A tangible good may include one or more of clothing, a toy, a figurine, a sticker, a pin, and/or other goods. The modifiable features of a design component may include one or more of a graphic element, color, shape, location, orientation, literal elements (e.g., character(s) including one or more of letters, numbers, symbols, and/or other elements), and/or other features.

In some implementations, personalizable benefit items may include one or more digital assets that make up the design component(s). By way of non-limiting illustration, a digital asset may include an image of a graphic. The digital asset may then be used to generate (e.g., manufacture) a real asset on a tangible good, for example, through one or more of printing, etching, embroidering, and/or other forms of manufacture.

By way of non-limiting illustration, a personalizable benefit item may comprise an article of clothing having a design component. The design component may include, for example, a logo. The logo may include a set of one or more modifiable features. By way of non-limiting illustration, the one or more modifiable features may include color of the logo, words appearing on the logo, location and/or orientation of the logo on the article of clothing, and/or other features. The logo may be represented, on a computer, as a digital asset. The digital asset may include, for example, a JPEG of the logo.

Identification component 110 may be configured to obtain input information. Input information may convey input by the content creators into the reward fulfilment user interface. The input by individual content creators may include one or more of identification of individual personalizable benefit items, identification of individual subscribers to the individual content creators, specification of timing information (described further herein), and/or other input. In some implementations, a list of available personalizable benefit items may be presented to be selected from. In some implementations, a text input box may be provided to input search queries for specific ones of the personalizable benefit items. In some implementations, a list of subscribers to a content creator may be presented to be selected from. In some implementations, a text input box may be provided to input search queries for specific ones of the subscribers. By way of non-limiting example, the input information may convey first input by a first content creator identifying one or more of a first benefit item, a first subscriber, and/or a second subscriber.

Identification component 110 may be further configured to, responsive to the identification of the individual subscribers, obtain subscribership information for the content creators. The subscribership information may characterize subscribership of the selected ones of the individual subscribers to the individual content creators. By way of non-limiting example, responsive to the identification of the first subscriber, first subscribership information characterizing the subscribership of the first subscriber to the first content creator may be obtained. By way of non-limiting example, responsive to the identification of the second subscriber, second subscribership information characterizing the subscribership of the second subscriber to the first content creator may be obtained.

Recommendation component 112 may be configured to determine individual recommendations for modifying individual sets of one or more modifiable features of the selected ones of the individual personalizable benefit items based on the subscribership information and/or other information. In some implementations, multiple recommendations may be determined for an individual subscriber. Individual ones of the multiple recommendations determined for an individual subscriber may reflect different subscribership information for that subscriber and/or the same subscribership information.

The individual recommendations may include modifications of individual modifiable features to reflect the subscribership information and/or other information. In some implementations, the modifications of the individual modifiable features may reflect the subscribership information by virtue of the modifications resulting in the individual modifiable features being representative of the subscribership information. The individual modifiable features may be representative of the subscribership information by virtue of including visual depictions of the subscribership information. By way of non-limiting illustration, individual modifiable features may include and/or visually reproduce at least some of the subscribership information.

By way of non-limiting illustration, certain subscribership information may dictate one or more modifications while other subscribership information may dictate other modification(s). By way of non-limiting illustration, subscribers having relatively longer length of subscribership may be recommended modifications that differ from subscribers having relatively longer length of subscribership. For example, a subscriber having a relatively longer length of subscribership may be recommended to have a graphic design element that is more colorful and/or larger than a subscriber having a relatively shorter length of subscribership. By way of non-limiting illustration, subscribers having a one year anniversary of subscribership may be recommended to have a graphic design element that indicates the one year of subscribership while subscribers having a one month anniversary of subscribership may be recommended to have a graphic design element that indicates the one month of subscribership.

In some implementations, modifying the individual sets of one or more modifiable features of the individual personalizable benefit items may include modifying digital assets that make up the design components of the benefit items prior to manufacture of the benefit items. In some implementations, the individual recommendations may present the individual digital assets modified based on the subscribership information and/or other information. The content creators may then review the modified digital assets prior to accepting them for sending to their subscribers. In some implementations, content creators may make changes and/or edits to the modified digital assets presented in the recommendations.

By way of non-limiting example, one or more of a first recommendation, a second recommendation, and/or other recommendations may be determined. The first recommendation may include a first modification of a first modifiable feature of the first benefit item to reflect the first subscribership information. The second recommendation may include a second modification of the first modifiable feature of the first benefit item to reflect the second subscribership information.

By way of non-limiting illustration, following the logo example above, the first recommendation may including modifying text appearing on the logo to reflect the first subscriber's username, while the second recommendation may including modifying the text appearing on the logo to reflect the second subscriber's username. By way of non-limiting illustration, following the logo example above, the first recommendation may including modifying a graphic design element of the logo to include a first graphic element of to reflect a first tier of the first user, while the second recommendation may including modifying the graphic design element of the logo to include a second graphic element to reflect a second tier of the second user. By way of non-limiting illustration, following the logo example above, the first recommendation may including modifying a graphic design element of the logo to include a first graphic element of a first size to reflect a lifetime pledge amount by the first user, while the second recommendation may including modifying the graphic design element of the logo to include the first graphic element of a second size to reflect the lifetime pledge amount by the second user. If the lifetime pledge amount by the first user is larger than that of the second user, the first size may be larger than the second size.

Presentation component 110 may be further configured to effectuate presentation of the individual recommendations in the reward fulfilment user interface presented on the computing platforms of the content creators. By way of non-limiting example, the first recommendation and/or the second recommendation may be presented on the reward fulfilment user interface presented on a first computing platform of the first content creator.

In some implementations, recommendation component 112 may be configured to obtain authorization input by the content creators into the reward fulfilment user interface. The authorization input may include one or more of selection of individual recommendations, selection of an “authorize” virtual button, and/or other input.

In some implementations, recommendation component 112 may be configured to effectuate communication of fulfilment instructions to a reward fulfillment system based on the authorization input and/or other information. In some implementations, recommendation component 112 may be configured to effectuate communication of fulfilment instructions to a reward fulfillment system in response to receiving the authorization input and/or other information. The reward fulfillment system may be an external resource included in the one or more external resources 116 may be an integral part of the system 100. In some implementations, a reward fulfillment system may comprise a system configured to effectuate the creation/manufacture of tangible goods. By way of non-limiting illustration, the reward fulfillment system may be configured to obtain fulfilment instructions to create/manufacture a tangible good, utilize the instructions to then create/manufacture the tangible good (e.g., manually and/or through machine intervention), pack the tangible good, ship the tangible good, and/or perform other operations. The reward fulfillment system may comprise one or both of automated computer tasks and/or instructions output to users via a computer prompting them to perform manual tasks.

In some implementations, the fulfilment instructions may cause the reward fulfillment system to create the personalized ones of the benefit items based on the individual personalizable benefit items. The individual personalizable benefit items may have the individual sets of one or more modifiable features modified in accordance with selected ones of the individual recommendations.

In some implementations, the fulfilment instructions may include timing information and/or other information. The timing information may dictate timing of creation and/or sending of the personalized ones of the benefit items to the subscribers. The timing of the creation and/or the sending of the personalized ones of the benefit items to the subscriber may be dictated based on the subscribership information of the subscribers meeting and/or exceeding a threshold. By way of non-limiting illustration, the subscribership information impacting the timing of the creation and/or the sending of the personalized ones of the benefit items may include one or more of length of subscribership, date of initial subscribership, a subscription level, rank among other subscribers, lifetime contribution amount, and/or other information. In some implementations, the timing information may be input by the content creators and/or determined automatically.

By way of non-limiting illustration, the timing of the creation and/or the sending of the personalized ones of the benefit items may be determined based on the lifetime contribution amount of an individual subscribers meeting and/or exceeding a threshold contribution amount. Once the lifetime contribution amount meets and/or exceeds the threshold contribution amount, the creation and/or the sending of a personalized benefit item to an individual subscriber may be effectuated. By way of non-limiting illustration, the timing of the creation and/or the sending of the personalized ones of the benefit items may be determined based on the date of initial subscribership meeting and/or exceeding a threshold date. By way of non-limiting illustration, threshold dates may include anniversary dates following the date of initial subscription, e.g., a 1-year anniversary, a 5-year anniversary, etc. Once the threshold date occurs, the creation and/or the sending of a personalized benefit item to an individual subscriber may be effectuated.

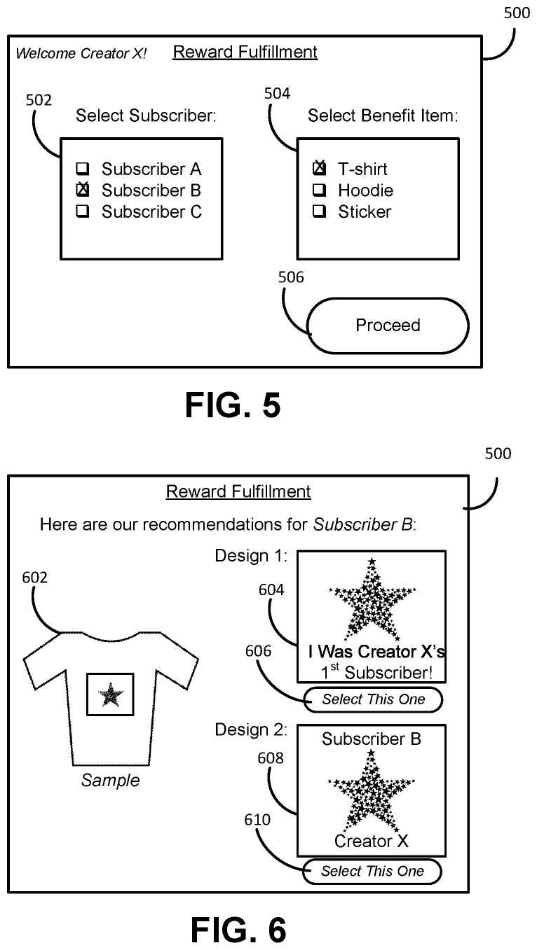

FIG. 5 illustrates a reward fulfillment user interface 500, in accordance with one or more implementations. For illustrative purposes, the reward fulfillment user interface 500 represents presentation on a computing platform of a content creator, referred to as “Creator X.” The reward fulfillment user interface 500 may be configured to receive user input defining input information. The user input by the content creator may include one or more of identification of an individual subscriber to the content creator, identification of a personalizable benefit item, and/or other information. By way of non-limiting illustration, a list 502 of subscribers to Creator X may be presented. An individual subscriber may be selected via selection of a check box, and/or other input. For illustrative purposes, Creator X has selected a subscriber, referred to as “Subscriber B.” “Subscriber B” may include the subscriber's name, username, and/or other identifying information. By way of non-limiting illustration, a list 504 of available personalizable benefit items may be presented. An individual personalizable benefit item may be selected via selection of a check box, and/or other input. For illustrative purposes, Creator X has selected a personalizable benefit item that is a “T-shirt.” The reward fulfillment user interface 500 may include a user interface element 506 to proceed to one or more further operations.

FIG. 6 illustrates the reward fulfillment user interface 500, in accordance with one or more implementations. In particular, the reward fulfillment user interface 500 may present one or more recommendations for modifying one or more modifiable features of the personalizable benefit item, e.g., the T-shirt, in response to obtaining subscribership information for Subscriber B. The one or more recommendations may include a first recommendation 604, a second recommendation 608, and/or other recommendations. In some implementations, individual recommendations may include individual digital assets modified based on the subscribership information of Subscriber B. By way of non-limiting illustration, the first recommendation 604 may include a digital asset of a design/logo having text appearing below it. The text in the first recommendation 604 may be based on the subscribership information of Subscriber B, for example, by including that Subscriber B was Creator X's first subscriber. By way of non-limiting illustration, the second recommendation 608 may include a digital asset of the design/logo having text appearing above and below it. The text in the second recommendation 608 may be based on the subscribership information of Subscriber B, for example, by including Subscriber B's username above, and Creator X's name below. A user interface element 606 may be selected as authorization input for the first recommendation 604. A user interface element 610 may be selected as authorization input for the second recommendation 608. In some implementations, a digital representation 602 of the benefit item (e.g., the T-shirt) may be presented on the reward fulfillment user interface 500 alongside the recommendations.

In some implementations, server(s) 102, remote computing platform(s) 104, and/or external resource(s) 116 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, remote computing platform(s) 104, and/or external resource(s) 116 may be operatively linked via some other communication media.

A given remote computing platform 104 may include one or more processors configured to execute one or more computer program components. The computer program components may be configured to enable an expert or user associated with the given remote computing platform 104 to interface with system 100, system 10, and/or external resource(s) 116, and/or provide other functionality attributed herein to remote computing platform(s) 104. By way of non-limiting example, the given remote computing platform 104 may include one or more of a desktop computer, a laptop computer, a handheld computer, a tablet computing platform, a NetBook, a Smartphone, a gaming console, and/or other computing platforms.

External resource(s) 116 may include sources of information outside of system 100, external entities participating with system 100, and/or other resources. In some implementations, some or all of the functionality attributed herein to external resource(s) 116 may be provided by resources included in system 100.

Server(s) 102 may include electronic storage 118, one or more processors 120, and/or other components. Server(s) 102 may include communication lines, or ports to enable the exchange of information with a network and/or other computing platforms. Illustration of server(s) 102 in FIG. 2 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may comprise non-transitory storage media that electronically stores information. The electronic storage media of electronic storage 118 may include one or both of system storage that is provided integrally (i.e., substantially non-removable) with server(s) 102 and/or removable storage that is removably communicable with server(s) 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources). Electronic storage 118 may store software algorithms, information determined by processor(s) 120, information received from server(s) 102, information received from remote computing platform(s) 104, and/or other information that enables server(s) 102 to function as described herein.

Processor(s) 120 may be configured to provide information processing capabilities in server(s) 102. As such, processor(s) 120 may include one or more of a physical processor, a digital processor, an analog processor, a digital circuit designed to process information, an analog circuit designed to process information, a state machine, and/or other mechanisms for electronically processing information. Although processor(s) 120 is shown in FIG. 2 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. Processor(s) 120 may be configured to execute components 108, 110, and/or 112, and/or other components. Processor(s) 120 may be configured to execute components 108, 110, and/or 112, and/or other components by software; hardware; firmware; some combination of software, hardware, and/or firmware; and/or other mechanisms for configuring processing capabilities on processor(s) 120. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 are illustrated in FIG. 2 as being implemented within a single processing unit, in implementations in which processor(s) 120 includes multiple processing units, one or more of components 108, 110, and/or 112 may be implemented remotely from the other components. The description of the functionality provided by the different components 108, 110, and/or 112 described below is for illustrative purposes, and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, and/or 112. As another example, processor(s) 120 may be configured to execute one or more additional components that may perform some or all of the functionality attributed below to one of components 108, 110, and/or 112.

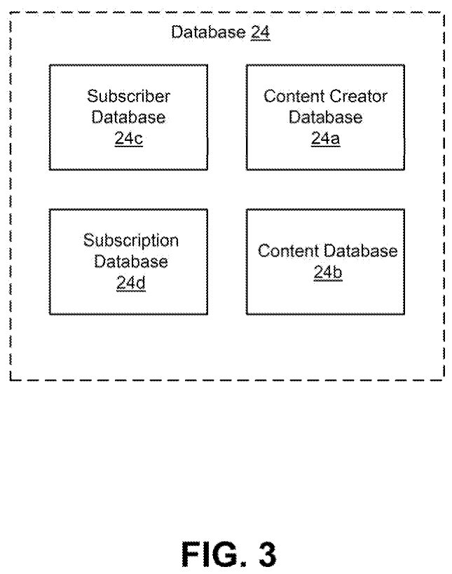

FIG. 3 illustrates elements that may make up database 24 of FIG. 1. As indicated previously, subscription component 18 of FIG. 1 may transmit information input by content creator 12 and/or consumer 14 regarding content information, subscribership information, and/or other information to database 24. Subscription platform 16, via server 22, for example, may monitor and obtain creation and/or subscribership information for storage in database 24. For example, subscription platform 16 may monitor and store additional information as well as performance-related subscribership information, e.g., engagement activity between content creator 12 and his/her subscribers, one of whom may be consumer 14. For example, subscription platform 16 of FIG. 1 may monitor the amount of money being generated and/or lost through the subscribers (e.g., outcome information), as well as content creator 12's subscriber retention rate. For example, subscription platform 16 may monitor and store performance-related creation information, such as the amount of content that content creator 12 is creating, how often and/or how quickly content creator 12 reacts to subscriber engagement activity, etc.

Database 24 may include one or more databases or partitions in which information relating to content creator 12, and/or subscribership relevant to content creator 12. For example, database 24 may include a content creator database 24a, a content database 24b, a subscriber database 24c, and a subscription database 24d. It should be noted that the elements and/or functionality of database 24 may be implemented in local memory resident in subscription component 18 or shared between database 24 and the local memory of subscription component 18 rather than solely in database 24.

Database 24 may be populated with one or more of content information, creator profile information, subscriber information, subscribership information, and/or other information.

Creator profile information characterizing content creator may be stored in content creator database 24a. The creator profile information may be information reflecting the creator type that content creator 12 designates him/herself to be and/or other self-identified preferences regarding subscription offerings by content creator 12. For example, content creator type may reflect that content creator may be a paint artist, a digital artist, a sculptor, a video game developer, a writer, a performance artist, etc. Content creator preferences may reflect subscription levels content creator 12 wishes to offer to subscribers. Content creator preferences may reflect, e.g., a desired minimum revenue, preferred sources of revenue, subscription level proportions, etc. For example, content creator preferences may include information indicating content creator's desire for more subscribers pledging some amount of money or less subscribers pledging a greater amount of money. For example, content creator preferences may include information specifying that content creator wishes to supplement his/her subscription-generated revenue with revenue generated from the sale of promotional merchandise.

In addition to content creation-related information, and upon registering with subscription platform as a content creator, content creator may input information characterizing the identity of content creator. For example, content creator may input or upload contact information, a telephone number associated with a personal user device, such as smartphone, an email address, a photograph, and/or other identifying information. Such identifying information may be used by subscription platform in a variety of ways to associate content creator with particular content, his/her webpage, payment of subscription donations, and/or other information.

Consumers may subscribe to content creators by registering with subscription platform. During registration, consumers may input certain subscriber demographic information indicative of economic and/or social characteristics. Subscriber demographic information may reflect the yearly income of consumers, a geographic area in which consumer resides, the age of consumer, interests of consumer, etc. Subscriber information may include data regarding the amount of money consumer is currently pledged to donate to one or more content creators. Over time, as monitored and collected by subscription platform, subscriber information may include information regarding the amount of money consumer has previously donated to one or more content creators. Subscriber information, as monitored and obtained by subscription platform 16 may include an Internet Protocol (IP) address indicative of a current location of consumer 14 and/or an IP address indicating a payment source. Such information may be stored in subscriber database 24c.

Like content creators, consumers may input or upload other identifying information. For example, a photograph or phone number of a consumer may be used. Such information may be stored in subscriber database 24c.

Subscription level information may refer to information characterizing different subscription levels and corresponding preferential access information specified by content creators. For example, subscription level information may reflect that a ten dollar recurring donation is rewarded with a high-resolution digital image of artwork created during that month to consumers. Such subscriber level information may be stored in subscription database 24d. Subscribership information may be stored in subscription database 24d and/or other storage location.

It should be noted that other databases or partitions may make up database 24. For example, database 24 may include one or more databases or partitions for storing information including, but not limited to the following: preferential access information characterizing activity in which content creator engagements may refer to data reflecting the type of activity, the level and/or exclusivity of preferential access to that activity granted to consumer; subscriber and/or content creator engagement information characterizing interactions, the type and/or frequency of interactions between subscribers and content creators, and/or the medium over which interactions may occur; and historical subscription level and/or engagement information reflecting subscription level and/or engagement information monitored and gathered over one or more periods of time.

It should be noted that some of the information described above may not necessarily be required. It should be noted that information reflecting additional aspects of, e.g., the content, content creator, content creator preferences, and/or subscribership, is contemplated by the disclosure. For example, preferential access need not necessarily be offered for each subscription level. For example, subscriber data may include data reflecting particular content creators to which a subscriber pledges donations.

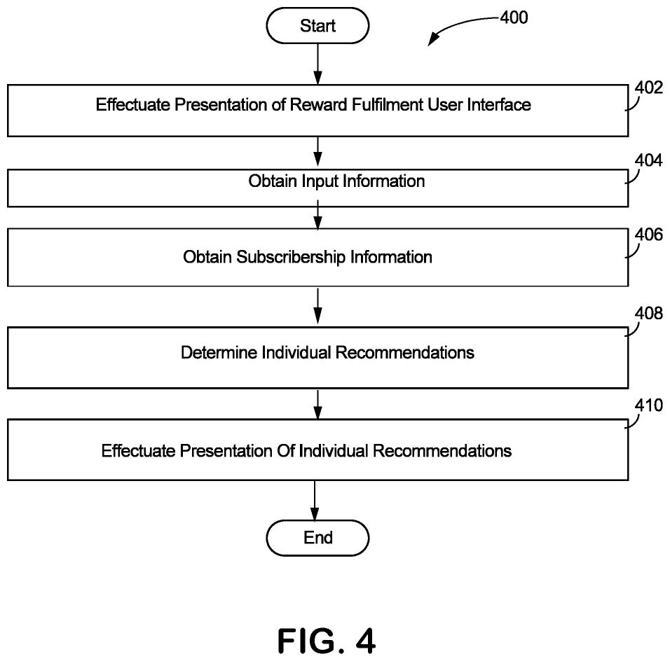

FIG. 4 illustrates a method 400 to generate personalized benefit items for subscribers of a membership platform, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a physical processor, digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include effectuating presentation of a reward fulfilment user interface to computing platforms of content creators of a membership platform. The content creators may offer benefit items to subscribers of the membership platform in exchange for requested amounts of consideration. The reward fulfillment user interface may facilitate the creation of personalized ones of the benefit items to the subscribers. Operation 402 may be performed by one or more hardware processors configured by machine-readable instructions including a component that is the same as or similar to presentation component 108.

An operation 404 may include obtaining input information. The input information may convey input by the content creators into the reward fulfilment user interface. The input by individual content creators may include identification of individual personalizable benefit items and identification of individual subscribers to the individual content creators. The individual personalizable benefit items may have individual sets of one or more modifiable features. Operation 404 may be performed by one or more hardware processors configured by machine-readable instructions including a component that is the same as or similar to identification component 110.

An operation 406 may include obtaining subscribership information for the content creators. The subscribership information may characterize subscribership of the individual subscribers to the individual content creators. Operation 406 may be performed by one or more hardware processors configured by machine-readable instructions including a component that is the same as or similar to identification component 110.

An operation 408 may include determining individual recommendations. The recommendations may be for modifying individual sets of one or more modifiable features of individual personalizable benefit items based on the subscribership information. The individual recommendations may include modifications of individual modifiable features to reflect the subscribership information. Operation 408 may be performed by one or more hardware processors configured by machine-readable instructions including a component that is the same as or similar to recommendation component 112.

An operation 410 may include effectuating presentation of individual recommendations in the reward fulfilment user interface presented on the computing platforms of the content creators. Operation 410 may be performed by one or more hardware processors configured by machine-readable instructions including a component that is the same as or similar to presentation component 108.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system configured to customize personalized physical merchandise items for subscribers of a membership platform, the system comprising:
one or more physical processors configured by machine-readable instructions to:
effectuate communication of user interface information from a server to remotely located client computing platforms associated with content creators of a membership platform, wherein the remotely located client computing platforms present a reward fulfilment user interface based on the user interface information, the content creators offering subscribership to subscribers of the membership platform in exchange for requested amounts of consideration, the subscribers receiving benefit items as part of the subscribership, the benefit items including physical merchandise items, the reward fulfillment user interface being configured for the design and creation of personalized ones of the physical merchandise items specific to individual ones of the subscribers;
obtain, by the server, input information conveying input by the content creators into the reward fulfilment user interface at the remotely boated client computing platforms, the input including identification of individual personalizable ones of the physical merchandise items and identification of the individual ones of the subscribers to the individual ones of the content creators, the individual personalizable ones of the physical merchandise items having individual sets of one or more modifiable features, such that the input information conveys first input into a first remotely located client computing platform associated with a first content creator, the first input identifying a first physical merchandise item, a first subscriber, and a second subscriber;
in response to the identification of the individual ones of the subscribers, obtain, by the server, subscribership information for the content creators; the subscribership information characterizing the subscribership of the individual ones of the subscribers to the individual ones of the content creators, such that in response to the identification of the first subscriber, first subscribership information characterizing the subscribership of the first subscriber to the first content creator is obtained, and in response to the identification of the second subscriber, second subscribership information characterizing the subscribership of the second subscriber to the first content creator is obtained;
determine, by the server, individual recommendations for modifying the individual sets of one or more modifiable features of the individual personalizable ones of the physical merchandise items based on the subscribership information, the individual recommendations including modifications of individual modifiable features to reflect the subscribership information specific to the individual ones of the subscribers, such that a first recommendation and a second recommendation are determined, the first recommendation including a first modification of a first modifiable feature of the first physical merchandise item to reflect the first subscribership information, the second recommendation including a second modification of the first modifiable feature of the first physical merchandise item to reflect the second subscribership information; and
update, by the server, the user interface information communicated to the remotely located client computing platforms to cause the individual recommendations to be displayed in the reward fulfilment user interface presented by the remotely located client computing platforms of the content creators, such that the first recommendation and the second recommendation are displayed in the reward fulfilment user interface presented by the first remotely located computing platform of the first content creator.

2. The system of claim 1, wherein the one or more physical processors are further configured by the machine-readable instructions to:
obtain authorization input by the content creators into the reward fulfilment user interface, the authorization input including selection of the individual recommendations; and
effectuate communication of fulfillment instructions to a reward fulfillment system based on the authorization input, wherein the fulfillment instructions cause the reward fulfillment system to create the personalized ones of the physical merchandise items based on the individual personalizable ones of the physical merchandise items having the individual sets of one or more modifiable features modified in accordance with selected ones of the individual recommendations.

3. The system of claim 2, wherein the fulfillment instructions further include timing information dictating timing of creation and/or sending of the personalized ones of the physical merchandise items to the subscribers.

4. The system of claim 3, wherein the timing of the sending of the personalized ones of the physical merchandise items to the subscribers is dictated based on the subscribership information of the subscribers meeting and/or exceeding a threshold.

5. The system of claim 1, wherein the modifications of the individual modifiable features reflect the subscribership information content by virtue of the modifications resulting in the individual modifiable features being representative of the subscribership information.

6. The system of claim 5, wherein the individual modifiable features are representative of the subscribership information by virtue of including visual depictions of the subscribership information, wherein the subscribership information includes one or more of length of subscribership, date of initial subscribership, a subscription level, rank among other subscribers, lifetime contribution amount, or subscriber-initiated interactions.

7. The system of claim 1, wherein the individual modifiable features include design components of the physical merchandise items.

8. The system of claim 7, wherein modifying the individual sets of one or more modifiable features of the individual personalizable ones of the physical merchandise items including modifying digital assets that make up the design components.

9. The system of claim 8, wherein the individual recommendations include individual digital assets modified based on the subscribership information.

10. The system of claim 1, wherein the subscribership information characterizing the subscribership of the individual subscribers includes one or more of length of subscribership, date of initial subscribership, a subscription level, rank among other subscribers, lifetime contribution amount, identifying information, or subscriber-initiated interactions.

11. A method to customize personalized physical merchandise items for subscribers of a membership platform, the method comprising:
effectuating communication of user interface information from a server to remotely located client computing platforms associated with content creators of a membership platform, wherein the remotely located client computing platforms present a reward fulfilment user interface based on the user interface information, the content creators offering subscribership to subscribers of the membership platform in exchange for requested amounts of consideration, the subscribers receiving benefit items as part of the subscribership, the benefit items including physical merchandise items, the reward fulfillment user interface being configured for the design and creation of personalized ones of the physical merchandise items specific to individual ones of the subscribers;
obtaining, by the server, input information conveying input by the content creators into the reward fulfilment user interface at the remotely located client computing platforms, the input including identification of individual personalizable ones of the physical merchandise items and identification of the individual ones of the subscribers to the individual ones of the content creators, the individual personalizable ones of the physical merchandise items having individual sets of one or more modifiable features, such that the input information conveys first input into a first remotely located client computing platform associated with a first content creator, the first input identifying a first physical merchandise item, a first subscriber, and a second subscriber;
in response to the identification of the individual ones of the subscribers, obtaining, by the server, subscribership information for the content creators, the subscribership information characterizing the subscribership of the individual ones of the subscribers to the individual ones of the content creators, including in response to the identification of the first subscriber, obtaining first subscribership information characterizing the subscribership of the first subscriber to the first content creator, and in response to the identification of the second subscriber, obtaining second subscribership information characterizing the subscribership of the second subscriber to the first content creator;
determining, by the server, individual recommendations for modifying the individual sets of one or more modifiable features of the individual personalizable ones of the physical merchandise items based on the subscribership information, the individual recommendations including modifications of individual modifiable features to reflect the subscribership information specific to the individual ones of the subscribers, including determining a first recommendation and a second recommendation, the first recommendation including a first modification of a first modifiable feature of the first physical merchandise item to reflect the first subscribership information, the second recommendation including a second modification of the first modifiable feature of the first physical merchandise item to reflect the second subscribership information; and
updating, by the server, the user interface information communicated to the remotely located client computing platforms to cause the individual recommendations to be displayed in the reward fulfilment user interface presented by the remotely located computing platforms of the content creators, including displaying the first recommendation and the second recommendation in the reward fulfilment user interface presented by the first remotely boated computing platform of the first content creator.

12. The method of claim 11, further comprising:
obtaining authorization input by the content creators into the reward fulfilment user interface, the authorization input including selection of the individual recommendations; and
effectuating communication of fulfillment instructions to a reward fulfillment system based on the authorization input, wherein the fulfillment instructions cause the reward fulfillment system to create the personalized ones of the physical merchandise items based on the individual personalizable physical merchandise items having the individual sets of one or more modifiable features modified in accordance with selected ones of the individual recommendations.

13. The method of claim 12, wherein the fulfillment instructions further include timing information dictating timing of creation and/or sending of the personalized ones of the physical merchandise items to the subscribers.

14. The method of claim 13, wherein the timing of the sending of the personalized ones of the physical merchandise items to the subscribers is dictated based on the subscribership information of the subscribers meeting and/or exceeding a threshold.

15. The method of claim 11, wherein the modifications of the individual modifiable features reflect the subscribership information content by virtue of the modifications resulting in the individual modifiable features being representative of the subscribership information.

16. The method of claim 15, wherein the individual modifiable features are representative of the subscribership information by virtue of including visual depictions of the subscribership information, wherein the subscribership information includes one or more of length of subscribership, date of initial subscribership, a subscription level, rank among other subscribers, lifetime contribution amount, or subscriber-initiated interactions.

17. The method of claim 11, wherein the individual modifiable features include design components of the physical merchandise items.

18. The method of claim 17, wherein modifying the individual sets of one or more modifiable features of the individual personalizable ones of the physical merchandise items including modifying digital assets that make up the design components.

19. The method of claim 18, wherein the individual recommendations include individual digital assets modified based on the subscribership information.

20. The method of claim 11, wherein the subscribership information characterizing the subscribership of the individual subscribers includes one or more of length of subscribership, date of initial subscribership, a subscription level, rank among other subscribers, lifetime contribution amount, identifying information, or subscriber-initiated interactions.
